(19) United States
(12) Patent Application Publication
(10) Pub. No.: US 2026/0320386 A1
(43) Pub. Date: Oct. 15, 2026

(54) METHOD FOR CREATING MULTI-FUNCTIONAL ARTIFICIAL NEURAL NETWORKS

(71) Applicant: Frederick Cyril Brown, Cocoa, FL (US)

(72) Inventor: Frederick Cyril Brown, Cocoa, FL (US)

(21) Appl. No.: 19/574,858

(22) Filed: Mar. 23, 2026

Related U.S. Application Data
(60) Provisional application No. 63/776,267, filed on Mar. 24, 2025.

(51) Int. Cl. G06N 3/08

(52) U.S. Cl. CPC G06N 3/08

(57) ABSTRACT

A method enabling artificial neural networks to perform multiple functions selected at runtime through input data structure. Input data is structured as a vector comprising a function identifier portion and an operand portion. The network is trained on a multi-function dataset, where each training sample includes a function identifier, operand values, and the corresponding ground truth. After training, the network performs different functions based on the function identifier, with the same operand values producing different outputs when combined with different function identifiers. The method is demonstrated through four embodiments: unary Boolean functions, binary Boolean functions, arithmetic operations on 4-bit integers (addition and multiplication), and trigonometric functions (sine and cosine). The approach eliminates the need for multiple separate networks, network reconfiguration, or retraining when switching between functions, reducing storage requirements and computational overhead while enabling scalable multi-function capability.

### FIELD OF THE INVENTION

This invention relates to artificial neural networks, and more particularly to methods for enabling a single artificial neural network to perform multiple distinct functions selected at runtime without reconfiguration, retraining, or switching.

### BACKGROUND OF THE INVENTION

Conventional artificial neural networks are typically trained to perform a single specific function. Each different function requires either a separate network, reconfiguration of an existing network, or retraining of an existing network. The network architecture and trained parameters (weights and biases) embody the specific function. For example, a network trained to perform addition lacks the ability to perform multiplication without reconfiguration or retraining.

This paradigm creates several practical limitations. Deploying multiple functions requires maintaining multiple separate networks, increasing storage and memory requirements. Switching between functions requires loading different networks, introducing computational overhead. Scaling to N functions requires N separate networks, multiplying resource requirements proportionally.

Various approaches to neural network architecture have been disclosed in the prior art. Some prior art describes configurable architectures. See U.S. Pat. No. 5,073,876 to Murphy et al.; U.S. Pat. No. 10,867,247 to Teig et al. Other prior art describes networks with multiple gate types across nodes. See U.S. Pat. No. 12,242,946 to Pelosi et al. Still other prior art describes improved activation functions for better approximation of non-linear functions. See U.S. Pat. No. 6,453,206 to Soraghan et al. (using trigonometric activation functions for time-series prediction); U.S. Pat. No. 7,788,196 to Buscema (applying sinusoidal transformation before weighted summation to improve learning convergence); U.S. Pat. No. 5,357,597 to Aparicio et al. and U.S. Pat. No. 5,517,597 to Aparicio et al. (using periodic wave functions as activation functions to achieve Boolean completeness within individual neurons). These approaches address different problems such as node-level operations, network flexibility, learning optimization, and neuron-level computational completeness. All lack disclosure or suggestion of runtime function selection via input data structure.

Despite decades of neural network development, the paradigm has remained: one network equals one function. A need exists for a method enabling runtime function selection without requiring multiple networks, network training, or network reconfiguration.

### SUMMARY OF THE INVENTION

The present invention provides a method for enabling a single artificial neural network to perform multiple distinct functions, wherein the specific function to be performed is selected at runtime through data included in the input vector. This is accomplished through two key aspects: (1) structuring the input data to include both a function identifier and operand data, and (2) training the network with examples from multiple functions such that the network learns to recognize the function identifier and apply the corresponding function to the operand data.

The input data is structured as a vector comprising two distinct components: a function identifier and one or more operands. The function identifier is a unique sequence of one or more values encoded as floating-point numbers suitable for neural network processing. The operands are the input values to which the selected function will be applied, encoded appropriately for the data type and function. The complete input vector is formed by concatenating the function identifier and operand encodings in a consistent ordering arrangement.

The network is trained using a dataset that includes examples from multiple functions. Each training example comprises a function identifier, one or more operands, and the ground truth output for applying the specified function to those operands. Through exposure to this multi-function dataset, the network learns to recognize patterns in the function identifier and associate them with corresponding computational behaviors.

After training, the network can perform any of the trained functions by including the appropriate function identifier in the input vector. Function selection occurs at runtime via the function identifier in the input vector. The same operands with different function identifiers produce different outputs, without requiring network switching, reconfiguration, or retraining.

The invention is applicable to both discrete and continuous function types. For discrete functions with finite input spaces, the training dataset may comprise all possible combinations of function identifiers and operands, enabling the network to learn exact mappings. For continuous functions with infinite or very large input spaces, the training dataset comprises representative sample points from each function, and the network learns to approximate the functions and interpolate between training points.

The method is demonstrated through four embodiments: unary Boolean functions (4 functions), binary Boolean functions (16 functions), arithmetic operations on 4-bit integers (addition and multiplication), and trigonometric functions (sine and cosine). These embodiments demonstrate scalability across function types and complexity levels.

The embodiments employ foundational function sets—sets of functions sufficient to enable broader classes of related operations through composition, derivation, or algorithmic combination. Binary Boolean functions enable higher-order Boolean operations through composition. Addition and multiplication enable subtraction and division through derivation. Sine and cosine enable all standard trigonometric functions through division and reciprocation. This foundational approach demonstrates that the invention's scope extends beyond directly trained functions to encompass entire operational domains.

The invention provides several advantages over prior art. A single network replaces multiple specialized networks. Function selection is accomplished at runtime without network reconfiguration. Storage and deployment requirements are reduced. The approach is scalable to arbitrary function sets. These advantages exceed the capabilities of conventional single-function networks.

The invention may be implemented in software, dedicated hardware including FPGAs, ASICs, and neural network accelerators, or combinations thereof, with hardware implementations particularly benefiting from the elimination of reconfiguration overhead when switching between functions.

### BRIEF DESCRIPTION OF THE DRAWINGS

FIG. 1 is a flowchart illustrating the overall method for creating multi-functional artificial neural networks, showing the input vector structure (1) comprising a function identifier (2) and operand data (3), function selection via input structure (4), the multi-function neural network (5), and the output vector (6).

FIG. 2 illustrates the multi-function training data structure (7) comprising multiple function blocks (8, 9, and 10), each containing input data (X DATA) comprising function identifier (FID) values and operand data (OD), and output data (Y DATA) comprising ground truth outputs (GT), for n functions with m operands per function.

### DETAILED DESCRIPTION OF THE INVENTION

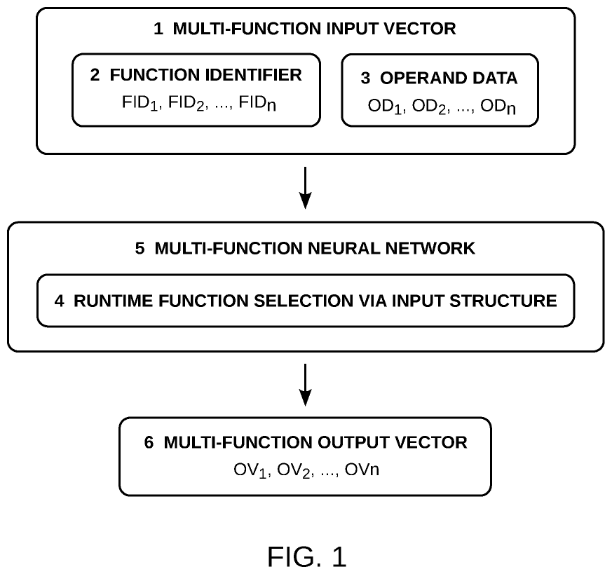

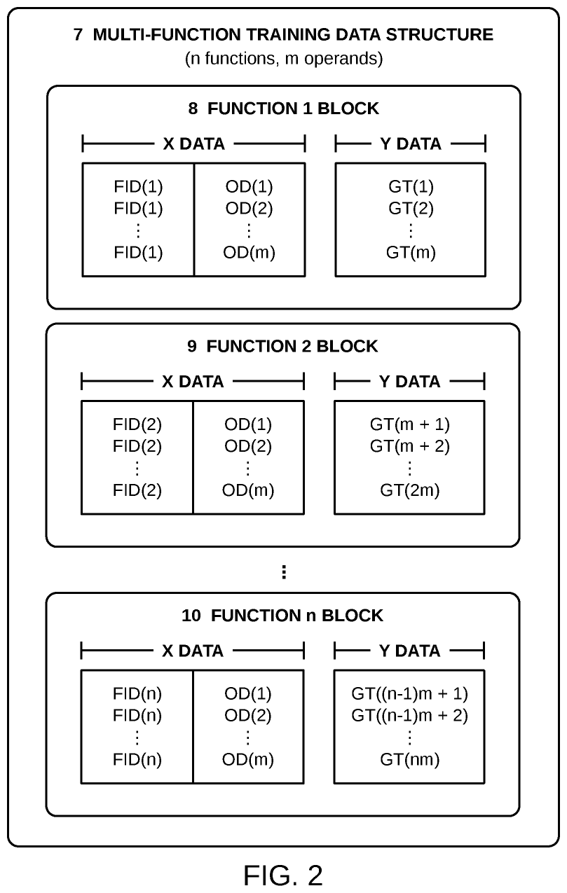

The present invention provides a method for enabling a single artificial neural network to perform multiple distinct functions, wherein the specific function to be performed is selected at runtime through data included in the input vector. This is accomplished through two key aspects: (1) structuring the input data to include both a function identifier and operand data (see FIG. 1, 1-3), and (2) training the network with examples from multiple functions such that the network learns to recognize the function identifier and apply the corresponding function to the operand data (see FIG. 2, 7-10).

The invention is applicable to both discrete and continuous function types. For discrete functions with finite input spaces (such as Boolean logic operations or arithmetic operations on fixed-precision operands), the training dataset may comprise all possible combinations of function identifiers and operands, enabling the network to learn exact mappings. For continuous functions with infinite or very large input spaces (such as trigonometric functions or other mathematical functions over continuous domains), the training dataset comprises representative sample points from each function, and the network learns to approximate the functions and interpolate between training points. In both cases, the fundamental principle remains the same: the function identifier in the input vector determines which function the network applies to the operands.

The input data is structured as a vector comprising two distinct components: a function identifier and one or more operands (see FIG. 1, 1). Both components are encoded as floating-point values suitable for neural network processing.

The function identifier is a unique sequence of one or more values that, after encoding, are represented as floating-point numbers suitable for neural network processing. The specific encoding scheme for the function identifier may vary depending on the embodiment. The key characteristic is that different function identifiers produce distinguishable input patterns that the network can learn to recognize.

The operands are the input values to which the selected function will be applied. The operand encoding depends on the nature of the data and the function to be performed. For Boolean operands, an affine encoding method may be used. For continuous operands, the values may be encoded directly as floating-point numbers, optionally normalized to a suitable range.

The complete input vector is formed by concatenating through an ordering arrangement the function identifier and operand encodings. The network processes this complete input vector to produce the output corresponding to the selected function applied to the provided operands.

The network is trained using a dataset that includes examples from multiple functions (see FIG. 2, 7-10). In standard machine learning terminology, the function identifiers and operand values constitute the input data (X DATA), while the ground truth outputs constitute the target data (Y DATA). Each training example comprises three components: a function identifier, one or more operands, and the ground truth output for applying the specified function to those operands. Through exposure to this multi-function dataset, the network learns to recognize patterns in the function identifier and associate them with corresponding computational behaviors.

The training process uses conventional neural network training methods, such as backpropagation and gradient descent optimization. The novelty, rather than in the training algorithm, exists in the structure of the training dataset, which includes the function identifiers and examples from multiple functions rather than just input and output data for a single function.

After training, the network can perform any of the trained functions by including the appropriate function identifier in the input vector. For discrete functions trained on exhaustive datasets, the network can achieve exact accuracy. For continuous functions trained on sample points, the network approximates the functions with accuracy depending on factors such as network architecture, training data density, and function smoothness.

Function selection occurs at runtime via the function identifier in the input vector (see FIG. 1, 4-6). The same operands with different function identifiers produce different outputs, without requiring network switching, reconfiguration, or retraining. This capability emerges from the combination of the structured input and multi-function training.

The invention provides several advantages over prior art. A single network replaces multiple specialized networks. Function selection is accomplished at runtime without network reconfiguration. Storage and deployment requirements are reduced. The approach is scalable to arbitrary function sets. These advantages exceed the capabilities of conventional single-function networks.

The method lacks limitation to specific function types. It is applicable to Boolean functions, arithmetic operations, trigonometric functions, and other function classes. The network topology may be adapted based on the complexity and the nature of the functions, while the core principle-function identifier in the input combined with multi-function training-remains constant across all embodiments.

The method and networks described herein may be implemented in various forms including software executing on general-purpose processors, dedicated hardware implementations, or combinations thereof. Hardware implementations are particularly well-suited to the multi-functional neural network architectures disclosed herein. Such hardware implementations may include, without limitation:
(a) Field-Programmable Gate Array (FPGA) implementations, wherein the network topology, weights, and activation functions are configured into programmable logic fabric, enabling high-speed parallel processing of the input vectors and efficient switching between functions based on the function identifier;
(b) Application-Specific Integrated Circuit (ASIC) implementations, wherein the network architecture is embodied in custom silicon optimized for the specific multi-function operations, providing maximum performance and energy efficiency;
(c) Hardware accelerator implementations, including neural network accelerators, tensor processing units, or other specialized processors designed for artificial neural network computation, wherein the multi-function capability is leveraged to reduce the number of distinct network models that must be loaded and switched during operation; and
(d) Hybrid implementations combining general-purpose processors with hardware acceleration, wherein the function identifier processing and operand encoding may be performed in software while the neural network forward propagation is performed in dedicated hardware.

These hardware implementations benefit particularly from the multi-function approach disclosed herein, as a single hardware configuration can perform multiple distinct functions without requiring reconfiguration of the hardware fabric, reloading of weight parameters, or switching between multiple hardware modules. The function selection via input data structure enables runtime function switching at the speed of data input, without the latency typically associated with hardware reconfiguration or model switching in conventional single-function neural network hardware implementations.

The embodiments described herein demonstrate the invention using foundational function sets-sets of functions sufficient to enable broader classes of related operations through composition, derivation, or algorithmic combination. This strategic selection of foundational functions demonstrates the invention's capability while establishing a basis for extended functionality without requiring direct embodiment of every possible operation.

For discrete Boolean operations, unary and binary Boolean functions (functions of one and two operands) form a foundational set because higher-order Boolean functions can be decomposed into compositions of unary and binary operations. For arithmetic operations, addition and multiplication form a foundational set because subtraction and division can be derived from them, and multi-digit operations can be constructed through iterative application. For trigonometric operations, sine and cosine form a foundational set because all other standard trigonometric functions (tangent, secant, cosecant, cotangent) can be computed through division and reciprocation of sine and cosine values.

This foundational function approach demonstrates that the invention's scope extends beyond the specific functions directly embodied in the training dataset. A network trained on foundational functions provides the capability to perform the entire class of related operations through conventional algorithmic combination of the foundational function outputs. The invention thereby enables multi-function capability at both the direct level (functions explicitly trained) and the derived level (functions computable from trained functions), while requiring training data and network capacity only for the foundational set.

Table 1 summarizes the foundational function approach across the disclosed embodiments. Each embodiment trains the network on a foundational set of functions sufficient to enable a broader class of related operations. The derived operations are performed through conventional algorithmic combination of the foundational function outputs, external to the network itself. This approach demonstrates that the invention's multi-functional capability extends beyond the directly trained functions to encompass entire operational domains, while requiring training data and network capacity only for the foundational sets.

TABLE 1
Foundational Function Sets and Derived Capabilities

| Embodiment | Foundational Functions | Derived Capabilities |
|---|---|---|
| Boolean | Unary: ZERO, IDENTITY, | Higher-order Boolean functions |
| | NOT, ONE | via composition of unary and |
| | Binary: All 16 binary | binary operations |
| | Boolean functions | |
| Arithmetic | ADD, MULTIPLY | SUBTRACT (via negation + ADD) |
| | | DIVIDE (via reciprocal + MULTIPLY) |
| | | Multi-digit operations (via |
| | | iterative application) |
| Trigonometric | SIN, COS | TAN = SIN/COS |
| | | SEC = 1/COS |
| | | CSC = 1/SIN |
| | | COT = COS/SIN |
| | | Trigonometric identities |

### Common Aspects of Boolean Embodiments

The first two embodiments demonstrate the invention using Boolean functions. Boolean functions operate on Boolean inputs (true/false or 1/0) and produce a Boolean output. These functions form the foundation of digital logic and are well-suited for demonstrating the core principle of the invention due to their discrete nature and finite input space.

Two separate embodiments are presented: a unary Boolean function embodiment operating on a single argument, and a binary Boolean function embodiment operating on two arguments. The unary embodiment encompasses four distinct functions, while the binary embodiment encompasses sixteen distinct functions. Each embodiment employs the same fundamental principle—function identification via input data structure—but differs in the specifics of network architecture and input vector size due to the different numbers of operands and functions involved.

Both embodiments share common characteristics in how Boolean values are encoded, how function identifiers are structured, and how input vectors are organized. These common aspects are described first, followed by the specific details of each embodiment.

Boolean values in both embodiments are represented as floating-point numbers suitable for neural network processing using an affine encoding method. This approach is standard practice in binarized neural networks (BNNs) and provides a systematic mapping from the Boolean domain {0, 1} to real-valued inputs.

The affine encoding function E: {0,1}→ [symbol] is defined as:

E(b)=α·b+β

where b is a Boolean value (0 or 1), a is a scaling parameter, and β is an offset parameter. This linear transformation maps Boolean false (0) to the real value β, and Boolean true (1) to the real value α+β.

In the present embodiments, a bipolar encoding is used with α=2 and β=−1, yielding:

E(0)=2·0+(−1)=−1.0

E(1)=2·1+(−1)=+1.0

This bipolar representation, where false and true are encoded as −1.0 and +1.0 respectively, creates a symmetrical encoding about zero. Such symmetrical encodings have been found to facilitate faster convergence during neural network training.

Alternative parameter values may be employed. For example, α=1 and β=0 yields an asymmetrical encoding where false maps to 0.0 and true maps to 1.0. However, experimentation has shown that the bipolar encoding (α=2, β=−1) generally produces superior training convergence.

This affine encoding method applies uniformly to all Boolean values in the input vector. Both operand values and function identifier values are Boolean in origin-drawn from the domain {0, 1}—and are transformed to real-valued inputs using the same encoding function E with the same parameters α and β. A Boolean input vector (b₁, b₂, . . . , bₙ) is thereby transformed into a corresponding vector of real-valued inputs (b₁, b₂, . . . , bₙ) supplied to the neural network.

The function identifier in both Boolean embodiments must satisfy two essential requirements: uniqueness and consistency. Each function must be associated with a unique identifier that distinguishes it from all other functions in the set. Additionally, the same identifier must be consistently used for a given function throughout training and runtime operation.

In the present embodiments, function identifiers are constructed using the return map of each Boolean function. A return map is the sequence of output values from the function's truth table, ordered by the binary enumeration of input combinations. For a unary function with one input, there are two possible input values (0 and 1), yielding a return map of two Boolean values. For a binary function with two inputs, there are four possible input combinations ((0,0), (0,1), (1,0), (1,1)), yielding a return map of four Boolean values. Each return map uniquely identifies its corresponding function.

Return map values are Boolean in nature, originating from the domain {0, 1}. Each element of the return map is either 0 (representing false) or 1 (representing true), corresponding to the output of the Boolean function for a particular input combination. These Boolean return map values are then encoded as real-valued inputs using the same affine encoding function E described previously. In the present embodiments with bipolar encoding (α=2, β=−1), each return map element is transformed: 0→−1.0 and 1→+1.0.

For example, consider the two-input AND function. Its truth table yields outputs of 0, 0, 0, 1 for input combinations (0,0), (0,1), (1,0), (1,1) respectively. The return map is therefore the Boolean sequence [0, 0, 0, 1]. After affine encoding, this becomes the real-valued sequence [−1.0, −1.0, −1.0, +1.0], which serves as the function identifier for AND in the input vector. Similarly, the XOR function has a Boolean return map of [0, 1, 1, 0], which encodes to [−1.0, +1.0, +1.0, −1.0].

The use of return maps as function identifiers provides human readability and intuitive correspondence between the identifier and the function's behavior. A person examining the input vector can immediately recognize which function is being invoked by inspecting the return map values and comparing them to known truth tables. However, this choice is made for convenience of understanding and documentation rather than technical necessity.

Alternative function identifier schemes could be employed, provided they maintain uniqueness and consistency. For instance, arbitrary Boolean sequences could be assigned to each function (e.g., [0, 1] for one function and [1, 0] for another in the unary case), even if those sequences do not correspond to the functions' actual return maps. Such arbitrary assignments would function equally well from the network's perspective, as the network learns through training to associate whatever identifier pattern is consistently presented with the corresponding computational behavior. The return map approach is selected because it makes the association between identifier and function behavior transparent to human observers, facilitating understanding and verification of the system's operation.

The input vector in both Boolean embodiments consists of two conceptual parts: the function identifier part and the operand part. The function identifier part occupies multiple elements of the input vector (two elements for unary functions, four elements for binary functions), while the operand part occupies one element per operand (one element for unary, two elements for binary).

A critical characteristic of the present invention is that the ordering of elements within the input vector is not constrained by the method. The function identifier elements and operand elements may be arranged in any order within the input vector, provided that a specific ordering is chosen and maintained consistently throughout training and runtime operation. This flexibility exists because the network layers are fully connected—each neuron in a given layer receives inputs from all neurons in the preceding layer. Through this full connectivity, the network learns during training which input positions correspond to which semantic roles (function identifier vs. operands), regardless of the chosen arrangement.

In the implemented embodiments described herein, a specific arrangement is used: operand elements are interleaved with function identifier elements. For the unary case, the arrangement is [FuncID₁, Operand, FuncID₂]. For the binary case, the arrangement is [Operand₁, FuncID₁, FuncID₂, FuncID₃, FuncID₄, Operand₂]. Although, numerous alternative arrangements are equally valid. For example, the binary case could be arranged as [FuncID₁, FuncID₂, FuncID₃, FuncID₄, Operand₁, Operand₂](function identifier first), or [Operand₁, Operand₂, FuncID₁, FuncID₂, FuncID₃, FuncID₄](operands first), or any other permutation of the six elements. The specific arrangement chosen in the described embodiments is presented as one example among many possibilities.

The essential requirement is consistency: whatever arrangement is chosen must be used uniformly across all training examples and all runtime inputs. The network learns the significance of each input position through exposure to consistently structured training data. Once trained with a particular arrangement, the network expects inputs to follow that same arrangement during operation.

The Boolean embodiments demonstrate the invention using foundational function sets selected for their sufficiency in enabling broader Boolean operations. The unary embodiment encompasses all four unary Boolean functions, which form a complete set for single-operand operations. The binary embodiment encompasses all sixteen binary Boolean functions, which form a foundational set for Boolean logic of arbitrary complexity.

The unary and binary Boolean functions are foundational because any Boolean function of three or more operands can be decomposed into a composition of unary and binary Boolean functions. For example, a three-input majority function can be expressed as a combination of AND and OR operations on pairs of inputs. Similarly, any Boolean expression involving multiple variables can be reduced to a sequence of two-input operations through standard Boolean algebra techniques.

By training networks on the complete set of unary and binary Boolean functions respectively, the invention provides the capability to evaluate arbitrary Boolean expressions through sequential application of the trained networks to intermediate results. A complex Boolean expression is decomposed into unary and binary operations, each operation is evaluated by invoking the appropriate function through the input vector structures, and the results are combined according to the expression's structure. The networks thereby enables Boolean computation of arbitrary complexity without requiring explicit training on higher-order functions.

### Embodiment 1: Unary Boolean Function Network

The first embodiment demonstrates the invention using unary Boolean functions—functions that accept a single Boolean operand and produce a Boolean output. There are exactly four distinct unary Boolean functions, which exhaustively cover all possible mappings from a single Boolean input to a Boolean output.

The four unary Boolean functions are: ZERO (constant false), IDENTITY (returns the input unchanged), NOT (logical negation), and ONE (constant true). These functions are defined by their truth tables:

| Input | ZERO | IDENTITY | NOT | ONE |
|---|---|---|---|---|
| 0 | 0 | 0 | 1 | 1 |
| 1 | 0 | 1 | 0 | 1 |

The ZERO function always returns false regardless of input. The IDENTITY function returns its input unchanged. The NOT function returns the logical negation of its input. The ONE function always returns true regardless of input. Together, these four functions represent the complete set of unary Boolean operations.

Each unary function is identified by a function identifier constructed from its return map—the sequence of outputs corresponding to inputs 0 and 1, in that order. Since there are two possible input values, each return map consists of two Boolean values.

The return maps for the four unary functions are:

| | |
|---|---|
| ZERO: | [0, 0] |
| IDENTITY: | [0, 1] |
| NOT: | [1, 0] |
| ONE: | [1, 1] |

These Boolean return map values are encoded using the bipolar affine encoding described previously (α=2, β=−1), transforming each Boolean value to its real-valued representation: 0→−1.0 and 1→+1.0. The encoded return maps become:

| | |
|---|---|
| ZERO: | [−1.0, −1.0] |
| IDENTITY: | [−1.0, +1.0] |
| NOT: | [+1.0, −1.0] |
| ONE: | [+1.0, +1.0] |

These encoded return maps serve as the function identifiers in the input vector. Each two-element sequence uniquely identifies one of the four unary functions.

The input vector for the unary embodiment consists of three elements: two elements for the function identifier (the encoded return map) and one element for the operand. In the implemented embodiment, these elements are arranged as [FuncID₁, Operand, FuncID₂], where FuncID₁ is the first element of the function identifier, Operand is the encoded input value, and FuncID₂ is the second element of the function identifier.

For example, to invoke the NOT function with operand 0 (false), the input vector would be constructed as follows. The NOT function has return map [1, 0], which encodes to [+1.0, −1.0]. The operand 0 encodes to −1.0. The complete input vector is therefore [+1.0, −1.0, −1.0], representing [FuncID₁, Operand, FuncID₂].

Similarly, to invoke the IDENTITY function with operand 1 (true), the return map [0, 1] encodes to [−1.0, +1.0], the operand 1 encodes to +1.0, and the complete input vector is [−1.0, +1.0, +1.0].

As noted previously, this particular arrangement of elements is one valid choice among many. Alternative arrangements such as [Operand, FuncID₁, FuncID₂] or [FuncID₁, FuncID₂, Operand] would function equally well, provided the chosen arrangement is used consistently throughout training and operation.

The unary embodiment employs a feedforward neural network with three layers: an input layer, a hidden layer, and an output layer. The input layer consists of three neurons corresponding to the three elements of the input vector. The hidden layer consists of four neurons, providing sufficient capacity for the network to learn the four distinct functions. The output layer consists of a single neuron producing the function result.

The network architecture is therefore designated as 3-4-1, indicating three input neurons, four hidden neurons, and one output neuron. Each neuron in the hidden layer receives weighted connections from all three input neurons. The output neuron receives weighted connections from all four hidden neurons. This fully connected architecture enables the network to learn arbitrary associations between input patterns and outputs.

The hidden layer neurons employ a hyperbolic tangent (tanh) activation function, which maps the weighted sum of inputs to the range (−1, +1). This activation function is well-suited to the bipolar encoding scheme, as it naturally operates in the same range as the encoded Boolean values. The output neuron also employs a tanh activation function, producing outputs in the range (−1, +1) corresponding to the encoded Boolean values −1.0 (false) and +1.0 (true).

The network contains trainable parameters (weights and biases) that are adjusted during training. The input-to-hidden layer contains 3×4=12 weights plus 4 biases (16 parameters). The hidden-to-output layer contains 4×1=4 weights plus 1 bias (5 parameters). The total number of trainable parameters is therefore 21.

This architecture represents a minimal configuration sufficient for learning the four unary Boolean functions. Larger architectures with additional hidden neurons or additional hidden layers could also be employed, potentially offering faster convergence or greater robustness, but the 3-4-1 architecture demonstrates that the invention does not require excessive network capacity.

The training dataset for the unary embodiment consists of all possible combinations of function identifiers and operand values. With four functions and two possible operand values (0 and 1), there are 4×2=8 unique training samples. This exhaustive dataset ensures that the network is exposed to every possible input configuration during training.

Table 2 presents the complete training dataset. For each training sample, the table shows the function being invoked, its Boolean return map, the Boolean operand value, the complete encoded input vector supplied to the network, and the expected encoded output value.

TABLE 2
Complete Training Dataset for Unary Boolean Functions

| Function | Return Map | Operand | Input Vector | Output |
|---|---|---|---|---|
| ZERO | [0, 0] | 0 | [−1.0, −1.0, −1.0] | −1.0 |
| ZERO | [0, 0] | 1 | [−1.0, +1.0, −1.0] | −1.0 |
| IDENTITY | [0, 1] | 0 | [−1.0, −1.0, +1.0] | −1.0 |
| IDENTITY | [0, 1] | 1 | [−1.0, +1.0, +1.0] | +1.0 |
| NOT | [1, 0] | 0 | [+1.0, −1.0, −1.0] | +1.0 |
| NOT | [1, 0] | 1 | [+1.0, +1.0, −1.0] | −1.0 |
| ONE | [1, 1] | 0 | [+1.0, −1.0, +1.0] | +1.0 |
| ONE | [1, 1] | 1 | [+1.0, +1.0, +1.0] | +1.0 |

Each row in the table represents one training example. The network learns to produce the correct output for each input vector through repeated exposure to these examples during training. The small size of the dataset (8 samples) makes exhaustive training computationally inexpensive while ensuring complete coverage of the input space.

The training samples can be presented to the network in any order. In the implemented embodiment, the samples are shuffled randomly at the beginning of each training epoch to prevent the network from learning order-dependent patterns. This shuffling is a standard practice in neural network training and helps ensure that the learned associations are based on the input-output relationships rather than the sequence of presentation.

The network is trained using standard backpropagation with stochastic gradient descent (SGD). The training process iteratively adjusts the network's weights and biases to minimize the difference between the network's predicted outputs and the ground truth outputs specified in the training dataset.

The loss function used is mean squared error (MSE), which measures the average squared difference between predicted and target outputs across all training samples. For a single training sample with predicted output y and target output y, the loss is (ŷ−y)² The total loss for an epoch is the average of the losses across all training samples.

Training proceeds in epochs, where each epoch consists of one complete pass through all training samples. At the beginning of each epoch, the training samples are shuffled randomly. For each sample, the network performs a forward pass to compute the predicted output, calculates the loss, and performs a backward pass to compute gradients of the loss with respect to all weights and biases. The weights and biases are then updated in the direction that reduces the loss, with the step size controlled by a learning rate hyperparameter.

In the implemented embodiment, training is performed for 100 epochs with a learning rate of 0.01. These hyperparameters were selected through experimentation and provide reliable convergence to a solution with perfect accuracy. The learning rate of 0.01 is relatively large, which is appropriate given the small dataset size and simple problem structure. The 100 epochs ensure that the network has sufficient exposure to the training data to learn the associations thoroughly.

The network weights and biases are initialized randomly at the start of training using a standard initialization scheme (Xavier/Glorot initialization), which sets initial values based on the number of inputs and outputs for each layer. This initialization helps ensure that gradients flow effectively through the network during the early stages of training.

Training typically converges very rapidly, often achieving perfect classification accuracy within the first two epochs. In the implemented embodiment with the specified hyperparameters, convergence to zero classification error commonly occurs in epoch 2. The mean squared error decreases sharply within the first several tens of epochs as the network learns to distinguish the function identifiers and associate them with the corresponding operations. The training process is deterministic given a fixed random seed for weight-initialization and sample shuffling, allowing for reproducible results.

The network's continuous output values are decoded to Boolean results by applying a threshold decision boundary. The decision boundary is set at the median value between the two encoded Boolean values. For the bipolar encoding used in this embodiment (−1.0 for false, +1.0 for true), the median value is 0.0. Output values greater than or equal to 0.0 are decoded as true (+1.0), while output values less than 0.0 are decoded as false (−1.0). This threshold-based decoding is appropriate for any affine encoding scheme; for example, with unipolar encoding where false maps to 0.0 and true maps to 1.0, the decision boundary would be 0.5.

After training, the network achieves perfect accuracy on all eight training samples. When presented with any of the input vectors from the training dataset, the network produces an output that, when classified according to the decision boundary, exactly matches the expected output.

The network's learned behavior demonstrates the core principle of the invention: the same operand value produces different outputs depending on the function identifier included in the input vector. For example, with operand 1 (encoded as +1.0):
ZERO function [−1.0, +1.0, −1.0]→output −1.0 (false)
IDENTITY function [−1.0, +1.0, +1.0]→output +1.0 (true)
NOT function [+1.0, +1.0, −1.0]→output −1.0 (false)
ONE function [+1.0, +1.0, +1.0]→output +1.0 (true)

The middle element of each input vector (+1.0) is identical, representing operand 1, yet the outputs differ based on the function identifier elements (the first and third elements). This demonstrates that the network has learned to recognize the function identifier and apply the corresponding function to the operand.

Similarly, with operand 0 (encoded as −1.0), the network produces different outputs for different function identifiers, correctly implementing each of the four functions.

To illustrate the network's operation after training, consider several example predictions. These examples show the input vector supplied to the network, the raw output value produced by the network, and the decoded Boolean result obtained by rounding the output to the nearest encoded Boolean value.

### Example 1: NOT Function with Operand 0

Input vector: [+1.0, −1.0, −1.0]
Function identifier: [+1.0, −1.0](NOT function)
Operand: −1.0 (Boolean 0)
Network output: +0.9987
Decoded result: +1.0 (Boolean 1)
Expected result: +1.0 (Boolean 1)
Interpretation: NOT(0)=1

### Example 2: IDENTITY Function with Operand 1

Input vector: [−1.0, +1.0, +1.0]
Function identifier: [−1.0, +1.0](IDENTITY function)
Operand: +1.0 (Boolean 1)
Network output: +0.9992
Decoded result: +1.0 (Boolean 1)
Expected result: +1.0 (Boolean 1)
Interpretation: IDENTITY(1)=1

### Example 3: ZERO Function with Operand 1

Input vector: [−1.0, +1.0, −1.0]
Function identifier: [−1.0, −1.0](ZERO function)
Operand: +1.0 (Boolean 1)
Network output: −0.9995
Decoded result: −1.0 (Boolean 0)
Expected result: −1.0 (Boolean 0)
Interpretation: ZERO(1)=0

### Example 4: ONE Function with Operand 0

Input vector: [+1.0, −1.0, +1.0]
Function identifier: [+1.0, +1.0](ONE function)
Operand: −1.0 (Boolean 0)
Network output: +0.9989
Decoded result: +1.0 (Boolean 1)
Expected result: +1.0 (Boolean 1)
Interpretation: ONE(0)=1

These examples demonstrate that the network produces outputs very close to the ideal encoded Boolean values (−1.0 and +1.0), with typical deviations of less than 0.002. The small deviations are due to the continuous nature of the neural network's activation functions and the finite precision of the learned weights and biases. When decoded using the threshold decision boundary, all predictions are exactly correct.

The examples also illustrate the key principle: changing the function identifier while keeping the operand constant produces different outputs. Comparing Examples 2 and 3, both have operand +1.0, but Example 2 (IDENTITY) produces output +1.0 while Example 3 (ZERO) produces output −1.0. This difference is entirely due to the function identifier, demonstrating that the network has learned to select and apply different functions based on the input data structure.

The unary embodiment thus successfully demonstrates the invention's core principle in a minimal, easily verifiable form. A single network with 21 trainable parameters learns to perform four distinct functions, selecting among them at runtime based on the function identifier included in the input vector, without requiring any network reconfiguration or switching.

### Embodiment 2: Binary Boolean Function Network

The second Boolean embodiment demonstrates the invention using binary Boolean functions-functions that accept two Boolean operands and produce a Boolean output. There are exactly sixteen distinct binary Boolean functions, which exhaustively cover all possible mappings from two Boolean inputs to a Boolean output.

The sixteen binary Boolean functions include commonly recognized operations such as AND, OR, XOR, NAND, NOR, and XNOR, as well as less commonly named functions such as implication, inhibition, and the constant and projection functions. Each function is uniquely defined by its truth table, which specifies the output for all four possible input combinations: (0,0), (0,1), (1,0), and (1,1).

For reference, the sixteen binary Boolean functions are: ZERO (constant false), AND, A AND NOT B, A (project first operand), B AND NOT A, B (project second operand), XOR, OR, NOR, XNOR, NOT B, B IMPLIES A, NOT A, A IMPLIES B, NAND, and ONE (constant true). Together, these sixteen functions represent the complete set of binary Boolean operations.

Each binary function is identified by a function identifier constructed from its return map—the sequence of outputs corresponding to input combinations (0,0), (0,1), (1,0), and (1,1), in that order. Since there are four possible input combinations, each return map consists of four Boolean values.

The return maps for several representative binary functions are:

| | |
|---|---|
| ZERO: | [0, 0, 0, 0] |
| AND: | [0, 0, 0, 1] |
| XOR: | [0, 1, 1, 0] |
| OR: | [0, 1, 1, 1] |
| NOR: | [1, 0, 0, 0] |
| XNOR: | [1, 0, 0, 1] |
| NAND: | [1, 1, 1, 0] |
| ONE: | [1, 1, 1, 1] |

These Boolean return map values are encoded using the bipolar affine encoding described previously (α=2, β=−1), transforming each Boolean value to its real-valued representation: 0→−1.0 and 1→+1.0. For example, the AND function's return map [0, 0, 0, 1] encodes to [−1.0, −1.0, −1.0, +1.0], and the XOR function's return map [0, 1, 1, 0] encodes to [−1.0, +1.0, +1.0, −1.0].

These encoded return maps serve as the function identifiers in the input vector. Each four-element sequence uniquely identifies one of the sixteen binary functions. The complete set of sixteen encoded return maps provides sixteen distinguishable patterns that the network learns to recognize during training.

The input vector for the binary embodiment consists of six elements: four elements for the function identifier (the encoded return map) and two elements for the operands. In the implemented embodiment, these elements are arranged as [Operand₁, FuncID₁, FuncID₂, FuncID₃, FuncID₄, Operand₂], where Operand₁ and Operand₂ are the encoded input values, and FuncID₁ through FuncID₄ are the four elements of the function identifier.

For example, to invoke the AND function with operands (0, 1), the input vector would be constructed as follows. The AND function has return map [0, 0, 0, 1], which encodes to [−1.0, −1.0, −1.0, +1.0]. The operands 0 and 1 encode to −1.0 and +1.0 respectively. The complete input vector is therefore [−1.0, −1.0, −1.0, −1.0, +1.0, +1.0], representing [Operand₁, FuncID₁, FuncID₂, FuncID₃, FuncID₄, Operand₂].

Similarly, to invoke the XOR function with operands (1, 0), the return map [0, 1, 1, 0] encodes to [−1.0, +1.0, +1.0, −1.0], the operands encode to +1.0 and −1.0, and the complete input vector is [+1.0, −1.0, +1.0, +1.0, −1.0, −1.0].

As noted previously, this particular arrangement of elements is one valid choice among many. Alternative arrangements such as placing all function identifier elements before both operands, or placing both operands before all function identifier elements, would function equally well, provided the chosen arrangement is used consistently throughout training and operation.

The binary embodiment employs a feedforward neural network with three layers: an input layer, a hidden layer, and an output layer. The input layer consists of six neurons corresponding to the six elements of the input vector. The hidden layer consists of four neurons, providing a minimal configuration for learning the sixteen distinct functions. The output layer consists of a single neuron producing the function result.

The network architecture is therefore designated as 6-4-1, indicating six input neurons, four hidden neurons, and one output neuron. Each neuron in the hidden layer receives weighted connections from all six input neurons. The output neuron receives weighted connections from all four hidden neurons. This fully connected architecture enables the network to learn arbitrary associations between input patterns and outputs.

The hidden layer neurons employ a hyperbolic tangent (tanh) activation function, which maps the weighted sum of inputs to the range (−1, +1). The output neuron also employs a tanh activation function, producing outputs in the range (−1, +1) corresponding to the encoded Boolean values −1.0 (false) and +1.0 (true).

The network contains trainable parameters (weights and biases) that are adjusted during training. The input-to-hidden layer contains 6×4=24 weights plus 4 biases (28 parameters). The hidden-to-output layer contains 4×1=4 weights plus 1 bias (5 parameters). The total number of trainable parameters is therefore 33.

This 6-4-1 architecture represents a minimal configuration sufficient for learning the sixteen binary Boolean functions. Alternative architectures with additional hidden neurons or additional hidden layers could also be employed. For example, a 6-8-1 architecture with eight hidden neurons, or a 6-16-8-1 architecture with two hidden layers, might offer faster convergence or greater robustness to noise. However, the 6-4-1 architecture demonstrates that the invention does not require excessive network capacity, as a network with only 33 trainable parameters successfully learns all sixteen functions.

The training dataset for the binary embodiment consists of all possible combinations of function identifiers and operand values. With sixteen functions and four possible operand combinations per function (corresponding to the four rows of each function's truth table: (0,0), (0,1), (1,0), (1,1)), there are 16×4=64 unique training samples. This exhaustive dataset ensures that the network is exposed to every possible input configuration during training.

Table 3 presents eight representative examples from the complete training dataset, showing a variety of function types. The complete 64-sample dataset follows the same structure, with each of the sixteen functions represented by four samples corresponding to the four possible operand combinations.

Each row in the table represents one training example. The complete dataset includes all 64 combinations, providing exhaustive coverage of the input space. The network learns to produce the correct output for each input vector through repeated exposure to these examples during training.

The training samples can be presented to the network in any order. In the implemented embodiment, the samples are shuffled randomly at the beginning of each training epoch to prevent the network from learning order-dependent patterns. This shuffling is a standard practice in neural network training and helps ensure that the learned associations are based on the input-output relationships rather than the sequence of presentation.

TABLE 3
Representative Training Examples for Binary Boolean Functions

| Function | Return Map | Op1 | Op2 | Input Vector | Output |
|---|---|---|---|---|---|
| AND | [0, 0, 0, 1] | 0 | 0 | [−1.0, −1.0, −1.0, −1.0, +1.0, −1.0] | −1.0 |
| AND | [0, 0, 0, 1] | 1 | 1 | [+1.0, −1.0, −1.0, −1.0, +1.0, +1.0] | +1.0 |
| OR | [0, 1, 1, 1] | 0 | 1 | [−1.0, −1.0, +1.0, +1.0, +1.0, +1.0] | +1.0 |
| XOR | [0, 1, 1, 0] | 1 | 0 | [+1.0, −1.0, +1.0, +1.0, −1.0, −1.0] | +1.0 |
| NAND | [1, 1, 1, 0] | 1 | 1 | [+1.0, +1.0, +1.0, +1.0, −1.0, +1.0] | −1.0 |
| NOR | [1, 0, 0, 0] | 0 | 0 | [−1.0, +1.0, −1.0, −1.0, −1.0, −1.0] | +1.0 |
| XNOR | [1, 0, 0, 1] | 1 | 0 | [+1.0, +1.0, −1.0, −1.0, +1.0, −1.0] | −1.0 |
| ONE | [1, 1, 1, 1] | 0 | 1 | [−1.0, +1.0, +1.0, +1.0, +1.0, +1.0] | +1.0 |

The network is trained using standard backpropagation with stochastic gradient descent (SGD). The training process iteratively adjusts the network's weights and biases to minimize the difference between the network's predicted outputs and the ground truth outputs specified in the training dataset.

The loss function used is mean squared error (MSE), which measures the average squared difference between predicted and target outputs across all training samples. For a single training sample with predicted output y and target output y, the loss is (ŷ−y)² The total loss for an epoch is the average of the losses across all training samples.

Training proceeds in epochs, where each epoch consists of one complete pass through all training samples. At the beginning of each epoch, the training samples are shuffled randomly. For each sample, the network performs a forward pass to compute the predicted output, calculates the loss, and performs a backward pass to compute gradients of the loss with respect to all weights and biases. The weights and biases are then updated in the direction that reduces the loss, with the step size controlled by a learning rate hyperparameter.

In the implemented embodiment, training is performed for 100 epochs with a learning rate of 0.01. These hyperparameters were selected through experimentation and provide reliable convergence to a solution with perfect accuracy. The network weights and biases are initialized randomly at the start of training using a standard initialization scheme (Xavier/Glorot initialization), which sets initial values based on the number of inputs and outputs for each layer.

Training typically converges rapidly, often achieving perfect classification accuracy within the first few epochs. The mean squared error decreases sharply during the initial epochs as the network learns to distinguish the function identifiers and associate them with the corresponding operations. The training process is deterministic given a fixed random seed for weight-initialization and sample shuffling, allowing for reproducible results.

Occasionally, depending on random weight-initialization, the binary network may fail to converge to a perfect solution within the specified number of epochs. Experimentation has shown this occurs in approximately 10% of training runs with random initialization. When convergence failure occurs, retraining with a different random initialization typically succeeds. This behavior is characteristic of neural network training with random initialization and is not specific to the multi-function approach.

The network's continuous output values are decoded to Boolean results by applying a threshold decision boundary, as described in the unary embodiment. The decision boundary is set at the median value between the two encoded Boolean values. For the bipolar encoding used in this embodiment (−1.0 for false, +1.0 for true), the median value is 0.0. Output values greater than or equal to 0.0 are decoded as true (+1.0), while output values less than 0.0 are decoded as false (−1.0).

After training, the network achieves perfect accuracy on all 64 training samples. When presented with any of the input vectors from the training dataset, the network produces an output that, when classified according to the decision boundary, exactly matches the expected output.

The network's learned behavior demonstrates the core principle of the invention: the same operand values produce different outputs depending on the function identifier included in the input vector. For example, with operands (1, 1) (both encoded as +1.0):
AND function produces output +1.0 (true)
NAND function produces output −1.0 (false)
OR function produces output +1.0 (true)
NOR function produces output −1.0 (false)
XOR function produces output −1.0 (false)
XNOR function produces output +1.0 (true)

The operand elements in each input vector are identical (both +1.0), yet the outputs differ based on the function identifier elements. This demonstrates that the network has learned to recognize the function identifier and apply the corresponding function to the operands.

Similarly, with any other operand combination such as (0, 1) or (1, 0), the network produces different outputs for different function identifiers, correctly implementing each of the sixteen functions.

To illustrate the network's operation after training, consider several example predictions. These examples show the input vector supplied to the network, the raw output value produced by the network, and the decoded Boolean result obtained by applying the decision boundary threshold.

### Example 1: AND Function with Operands (1, 1)

Input vector: [+1.0, −1.0, −1.0, −1.0, +1.0, +1.0]
Function identifier: [−1.0, −1.0, −1.0, +1.0](AND function)
Operands: +1.0, +1.0 (Boolean 1, 1)
Network output: +0.9983
Decoded result: +1.0 (Boolean 1)
Expected result: +1.0 (Boolean 1)
Interpretation: AND(1, 1)=1

### Example 2: XOR Function with Operands (1, 0)

Input vector: [+1.0, −1.0, +1.0, +1.0, −1.0, −1.0]
Function identifier: [−1.0, +1.0, +1.0, −1.0](XOR function)
Operands: +1.0, −1.0 (Boolean 1, 0)
Network output: +0.9976
Decoded result: +1.0 (Boolean 1)
Expected result: +1.0 (Boolean 1)
Interpretation: XOR(1, 0)=1

### Example 3: NAND Function with Operands (1, 1)

Input vector: [+1.0, +1.0, +1.0, +1.0, −1.0, +1.0]
Function identifier: [+1.0, +1.0, +1.0, −1.0](NAND function)
Operands: +1.0, +1.0 (Boolean 1, 1)
Network output: −0.9981
Decoded result: −1.0 (Boolean 0)
Expected result: −1.0 (Boolean 0)
Interpretation: NAND(1, 1)=0

### Example 4: OR Function with Operands (0, 1)

Input vector: [−1.0, −1.0, +1.0, +1.0, +1.0, +1.0]
Function identifier: [−1.0, +1.0, +1.0, +1.0](OR function)
Operands: −1.0, +1.0 (Boolean 0, 1)
Network output: +0.9988
Decoded result: +1.0 (Boolean 1)
Expected result: +1.0 (Boolean 1)
Interpretation: OR(0, 1)=1

### Example 5: NOR Function with Operands (0, 0)

Input vector: [−1.0, +1.0, −1.0, −1.0, −1.0, −1.0]
Function identifier: [+1.0, −1.0, −1.0, −1.0](NOR function)
Operands: −1.0, −1.0 (Boolean 0, 0)
Network output: +0.9979
Decoded result: +1.0 (Boolean 1)
Expected result: +1.0 (Boolean 1)
Interpretation: NOR(0, 0)=1

### Example 6: XNOR Function with Operands (1, 1)

Input vector: [+1.0, +1.0, −1.0, −1.0, +1.0, +1.0]
Function identifier: [+1.0, −1.0, −1.0, +1.0](XNOR function)
Operands: +1.0, +1.0 (Boolean 1, 1)
Network output: +0.9985
Decoded result: +1.0 (Boolean 1)
Expected result: +1.0 (Boolean 1)
Interpretation: XNOR(1, 1)=1

### Example 7: a AND NOT B Function with Operands (1, 0)

Input vector: [+1.0, −1.0, −1.0, +1.0, −1.0, −1.0]
Function identifier: [−1.0, −1.0, +1.0, −1.0](A AND NOT B function)
Operands: +1.0, −1.0 (Boolean 1, 0)
Network output: +0.9972
Decoded result: +1.0 (Boolean 1)
Expected result: +1.0 (Boolean 1)
Interpretation: (1 AND NOT 0)=1

### Example 8: ONE Function with Operands (0, 1)

Input vector: [−1.0, +1.0, +1.0, +1.0, +1.0, +1.0]
Function identifier: [+1.0, +1.0, +1.0, +1.0](ONE function)
Operands: −1.0, +1.0 (Boolean 0, 1)
Network output: +0.9991
Decoded result: +1.0 (Boolean 1)
Expected result: +1.0 (Boolean 1)
Interpretation: ONE(0, 1)=1

These examples demonstrate that the network produces outputs very close to the ideal encoded Boolean values (−1.0 and +1.0), with typical deviations of less than 0.003. The small deviations are due to the continuous nature of the neural network's activation functions and the finite precision of the learned weights and biases. When decoded using the threshold decision boundary, all predictions are exactly correct.

The examples also illustrate the key principle across a variety of function types: simple conjunctions (AND), disjunctions (OR), exclusive operations (XOR, XNOR), negated operations (NAND, NOR), asymmetric operations (A AND NOT B), and constant functions (ONE). In each case, changing the function identifier while keeping the operands constant produces different outputs, demonstrating that the network has learned to select and apply different functions based on the input data structure.

Comparing Examples 1 and 3 specifically illustrates this principle: both have identical operands (+1.0, +1.0), but Example 1 with the AND function identifier produces output +1.0, while Example 3 with the NAND function identifier produces output −1.0. This difference is entirely due to the function identifier, confirming that the network recognizes and responds to the function selection encoded in the input vector.

The binary embodiment thus successfully demonstrates the invention's scalability from four functions (unary) to sixteen functions (binary). A single network with 33 trainable parameters learns to perform sixteen distinct functions, selecting among them at runtime based on the function identifier included in the input vector, without requiring any network reconfiguration or switching.

### Embodiment 3: Arithmetic Function Embodiment

The third embodiment demonstrates the invention using arithmetic functions operating on 4-bit unsigned integers. This embodiment encompasses two distinct functions: addition (ADD) and multiplication (MULTIPLY). Each function accepts two 4-bit operands with values ranging from 0 to 15, and produces an integer result.

The addition function computes the sum of two operands, producing results in the range 0 to 30. The multiplication function computes the product of two operands, producing results in the range 0 to 225. These functions represent discrete operations with finite but substantially larger input spaces than the Boolean embodiments. With 16 possible values per operand and 2 operands, there are 256 distinct operand combinations per function, yielding 512 total training samples for the two functions.

This embodiment demonstrates that the invention scales beyond simple Boolean operations to arithmetic computations involving multi-bit operands and multi-bit outputs. The principles remain identical to the Boolean embodiments—function identification via input data structure and multi-function training—but the implementation details differ to accommodate the increased complexity of the operand encoding and output decoding.

The selection of addition and multiplication as the foundational arithmetic operations is strategic. These two operations form a sufficient basis for the four basic arithmetic operations: addition is directly provided, multiplication is directly provided, subtraction can be implemented through addition with negation (or through complement arithmetic for unsigned values), and division can be implemented through iterative subtraction or multiplication-based algorithms. Furthermore, multi-digit arithmetic operations on operands larger than 4 bits can be constructed through iterative application of the 4-bit operations using standard carry-propagation and digit-by-digit algorithms.

This foundational approach demonstrates that the arithmetic embodiment's capability extends beyond the 512 directly trained input-output mappings. The network provides the foundational operations from which a complete arithmetic system can be constructed, enabling computation on operands of arbitrary size and supporting all four basic arithmetic operations, while requiring training data only for addition and multiplication on 4-bit operands.

Each operand in the arithmetic embodiment is a 4-bit unsigned integer with values from 0 to 15. The operand is represented in standard binary notation, where the value is expressed as a sequence of four binary digits (bits) corresponding to the powers of 2: 2³, 2², 2¹, and 2⁰.

For example, the decimal value 5 is represented in binary as 0101, meaning 0·2³+1·2²+0·2¹+1·2⁰=0+4+0+1=5. Similarly, the decimal value 13 is represented as 1101, meaning 1·2³+1·2²+0·2¹+1·2⁰=8+4+0+1=13.

Each bit of the binary representation is a Boolean value (0 or 1), and these Boolean values are encoded using the same bipolar affine encoding employed in the Boolean embodiments. With α=2 and β=−1, each bit transforms as: 0→−1.0 and 1→+1.0. A 4-bit operand thereby becomes a sequence of four real-valued elements suitable for neural network processing.

For example, the operand 5 with binary representation 0101 encodes to the real-valued sequence [−1.0, +1.0, −1.0, +1.0]. The operand 13 with binary representation 1101 encodes to [+1.0, +1.0, −1.0, +1.0]. The operand 0 (binary 0000) encodes to [−1.0, −1.0, −1.0, −1.0], and the operand 15 (binary 1111) encodes to [+1.0, +1.0, +1.0, +1.0].

The arithmetic embodiment includes two functions, which requires a function identifier capable of distinguishing between them. A single bit suffices to represent two distinct states: one state for addition and another state for multiplication.

In the implemented embodiment, the function identifier is encoded as follows: the ADD function is assigned the Boolean value 0, and the MULTIPLY function is assigned the Boolean value 1. These Boolean values are then encoded using the bipolar affine encoding: ADD (0) maps to −1.0, and MULTIPLY (1) maps to +1.0.

However, rather than including a single function identifier element in the input vector, the implemented embodiment includes nine identical copies of the function identifier value. For the ADD function, the function identifier portion of the input vector consists of nine elements, each with value −1.0: [−1.0, −1.0, −1.0, −1.0, −1.0, −1.0, −1.0, −1.0, −1.0]. For the MULTIPLY function, the function identifier portion consists of nine elements, each with value +1.0: [+1.0, +1.0, +1.0, +1.0, +1.0, +1.0, +1.0, +1.0, +1.0].

This repetition of the function identifier value serves a practical purpose. The input vector contains eight operand bits (four bits per operand), representing the primary data to be processed. A single function identifier bit would constitute a relatively weak signal compared to the eight operand bits. By replicating the function identifier across nine elements, the function selection signal is strengthened relative to the operand data, facilitating the network's ability to distinguish between the two functions during training. Experimentation has shown that this 9-element function identifier encoding provides reliable function discrimination in conjunction with the 8-element operand encoding.

The input vector for the arithmetic embodiment consists of 17 elements total: 9 elements for the function identifier and 8 elements for the two operands (4 bits per operand). In the implemented embodiment, these elements are arranged as: function identifier elements first, followed by the first operand's bits, followed by the second operand's bits.

Specifically, the arrangement is: [FuncID₁, FuncID₂, . . . , FuncID₉, Op1₃, Op1₂, Op1₁, Op1₀, Op2₃, Op2₂, Op2₁, Op2₀], where the operand subscript numbers represent bits that are ordered from most significant (bit 3) to least significant (bit 0).

For example, to invoke the ADD function with operands 7 and 8, the input vector is constructed as follows. The ADD function identifier is nine copies of −1.0. The operand 7 has binary representation 0111, which encodes to [−1.0, +1.0, +1.0, +1.0]. The operand 8 has binary representation 1000, which encodes to [+1.0, −1.0, −1.0, −1.0]. The complete input vector is: [−1.0, −1.0, −1.0, −1.0, −1.0, −1.0, −1.0, −1.0, −1.0, −1.0, +1.0, +1.0, +1.0, +1.0, −1.0, −1.0, −1.0].

Similarly, to invoke the MULTIPLY function with operands 7 and 8, the function identifier is nine copies of +1.0, and the operands encode identically. The complete input vector is: [+1.0, +1.0, +1.0, +1.0, +1.0, +1.0, +1.0, +1.0, +1.0, −1.0, +1.0, +1.0, +1.0, +1.0, −1.0, −1.0, −1.0].

As with the Boolean embodiments, this particular arrangement of elements is one valid choice among many. Alternative arrangements such as interleaving function identifier elements with operand elements, or placing operands before the function identifier, would function equally well, provided the chosen arrangement is used consistently throughout training and operation. The fully connected network architecture enables the network to learn the semantic role of each input position regardless of the ordering.

The output of the arithmetic functions is an integer value that must be represented in a form suitable for neural network processing. The addition function produces results from 0 to 30, requiring 5 bits for complete representation (2⁵=32>30). The multiplication function produces results from 0 to 225, requiring 8 bits for complete representation (2⁸=256>225).

To accommodate both functions with a single network architecture, the output layer consists of 8 neurons, sufficient to represent the largest possible result (225 from multiplication). Each output neuron corresponds to one bit of the binary representation of the result, ordered from most significant bit to least significant bit.

Each output neuron produces a continuous value in the range (−1, +1) due to the tanh activation function. These continuous values are decoded to binary bits using the same threshold decision boundary employed in the Boolean embodiments. For bipolar encoding, the decision boundary is 0.0: output values greater than or equal to 0.0 are decoded as bit value 1, and output values less than 0.0 are decoded as bit value 0.

Once the 8 output values are decoded to 8 binary bits, these bits are interpreted as an 8-bit unsigned integer in standard binary notation. The integer value is computed as:

$$result = {\sum }_{i = 0}^{7} {b}_{i} \cdot {2}^{i} ,$$

where bᵢ is the decoded bit value (0 or 1) at position i, with i=0 corresponding to the least significant bit and i=7 corresponding to the most significant bit.

For example, if the network's 8 output neurons produce continuous values that decode to the bit sequence [0, 0, 0, 0, 1, 1, 1, 1](most significant bit first), this represents the binary number 00001111, which equals 1·2³+1·2²+1·2¹+1·2⁰=8+4+2+1=15 in decimal. Similarly, the bit sequence [0, 0, 1, 1, 1, 0, 0, 0] represents binary 00111000, which equals 1·2⁵+1·2⁴+1·2⁰=32+16+8=56 in decimal.

The arithmetic embodiment employs a feedforward neural network with four layers: an input layer, two hidden layers, and an output layer. The input layer consists of 17 neurons corresponding to the 17 elements of the input vector. The first-hidden-layer consists of 103 neurons. The second-hidden-layer consists of 43 neurons. The output layer consists of 8 neurons corresponding to the 8 bits of the output value.

The network architecture is therefore designated as 17-103-43-8, indicating 17 input neurons, 103 neurons in the first-hidden-layer, 43 neurons in the second-hidden-layer, and 8 output neurons. Each layer is fully connected to the subsequent layer: each neuron in the first-hidden-layer receives weighted connections from all 17 input neurons, each neuron in the second-hidden-layer receives weighted connections from all 103 first-hidden-layer neurons, and each output neuron receives weighted connections from all 43 second-hidden-layer neurons.

All neurons in both hidden layers and the output layer employ a hyperbolic tangent (tanh) activation function, which maps the weighted sum of inputs to the range (−1, +1). This activation function is consistent with the bipolar encoding scheme used for both inputs and outputs.

The network contains trainable parameters (weights and biases) that are adjusted during training. The input-to-first-hidden layer contains 17×10β=1751 weights plus 103 biases (1854 parameters). The first-hidden-to-second-hidden layer contains 103×4β=4429 weights plus 43 biases (4472 parameters). The second-hidden-to-output layer contains 43×8=344 weights plus 8 biases (352 parameters). The total number of trainable parameters is therefore 1854+4472+352=6678 parameters.

This architecture is substantially larger than the Boolean embodiments, reflecting the increased complexity of the arithmetic functions. The two-hidden-layer design provides the network with sufficient representational capacity to learn the mapping from 17-element input vectors to 8-element output vectors across 512 distinct training samples representing two different arithmetic operations.

The training dataset for the arithmetic embodiment consists of all possible combinations of function identifiers and operand values. With two functions (ADD and MULTIPLY) and 256 possible operand combinations per function (16 values for the first operand times 16 values for the second operand), there are 2×256=512 unique training samples. This exhaustive dataset ensures that the network is exposed to every possible input configuration during training.

Table 4 presents eight representative examples from the complete training dataset, showing a variety of operand values and both functions. The complete 512-sample dataset follows the same structure, with each of the two functions represented by 256 samples corresponding to all possible operand pairs.

Each row in the table represents one training example. For each example, the complete input vector would be constructed according to the encoding schemes described previously: 9 function identifier elements followed by 4 bits for the first operand followed by 4 bits for the second operand, with all bits encoded in bipolar form. The output encoding shows the expected 8-bit binary representation of the result. The network learns to produce the correct output bit pattern for each input vector through repeated exposure to these examples during training.

The network is trained using standard backpropagation with stochastic gradient descent (SGD). The training process iteratively adjusts the network's weights and biases to minimize the difference between the network's predicted outputs and the ground truth outputs specified in the training dataset.

TABLE 4
Representative Training Examples for Arithmetic Functions

| Function | Op1 | Op2 | Result | Output Encoding (8 bits) |
|---|---|---|---|---|
| ADD | 7 | 8 | 15 | [0, 0, 0, 0, 1, 1, 1, 1] |
| MULTIPLY | 7 | 8 | 56 | [0, 0, 1, 1, 1, 0, 0, 0] |
| ADD | 0 | 0 | 0 | [0, 0, 0, 0, 0, 0, 0, 0] |
| MULTIPLY | 0 | 0 | 0 | [0, 0, 0, 0, 0, 0, 0, 0] |
| ADD | 15 | 15 | 30 | [0, 0, 0, 1, 1, 1, 1, 0] |
| MULTIPLY | 15 | 15 | 225 | [1, 1, 1, 0, 0, 0, 0, 1] |
| ADD | 5 | 10 | 15 | [0, 0, 0, 0, 1, 1, 1, 1] |
| MULTIPLY | 5 | 3 | 15 | [0, 0, 0, 0, 1, 1, 1, 1] |

The loss function used is mean squared error (MSE), which measures the average squared difference between predicted and target outputs across all output neurons and all training samples. For a single training sample with 8 predicted output values ŷ₁, . . . , ŷ₈ and 8 target output values y₁, . . . , y₈, the loss is

$$\frac{1}{8} {\sum }_{i = 1}^{8} {( {\hat{y}}_{i} - {y}_{i} )}^{2} .$$

The total loss for an epoch is the average of the losses across all training samples.

Training proceeds in epochs, where each epoch consists of one complete pass through all 512 training samples. At the beginning of each epoch, the training samples are shuffled randomly. For each sample, the network performs a forward pass to compute the predicted outputs, calculates the loss, and performs a backward pass to compute gradients of the loss with respect to all weights and biases. The weights and biases are then updated in the direction that reduces the loss, with the step size controlled by a learning rate hyperparameter.

In the implemented embodiment, training is performed for 200 epochs with an adaptive learning rate schedule. The learning rate begins at 0.01 and is adjusted based on training progress. As the network's accuracy improves, the learning rate is reduced to enable finer adjustments to the weights. The learning rate progresses from the initial value of 0.01 to 0.005 as accuracy increases, and finalizes at 0.001 for the later stages of training. This adaptive schedule facilitates both rapid initial learning and precise convergence to an accurate solution.

The network weights and biases are initialized randomly at the start of training using a standard initialization scheme (Xavier/Glorot initialization), which sets initial values based on the number of inputs and outputs for each layer. This initialization helps ensure that gradients flow effectively through the network during the early stages of training.

Training converges very reliably in the arithmetic embodiment. Across multiple training runs with different random initializations, convergence to perfect classification accuracy consistently occurs at approximately epoch 176, with variation of only one or two epochs. This stability indicates that the network architecture and training hyperparameters are well-suited to the problem. No convergence failures have been observed in the training runs conducted.

The network's continuous output values are decoded to binary bits by applying a threshold decision boundary at 0.0, as described previously. Output values from each of the 8 output neurons are classified as bit 1 if greater than or equal to 0.0, or bit 0 if less than 0.0. The resulting 8-bit binary sequence is then converted to an integer result. A prediction is considered correct if the decoded integer exactly matches the expected result for the given function and operands.

After training, the network achieves perfect accuracy on all 512 training samples. When presented with any of the input vectors from the training dataset, the network produces output values that, when decoded to an 8-bit integer, exactly match the expected result of applying the specified function to the provided operands.

The network's learned behavior demonstrates the core principle of the invention: the same operand values produce different outputs depending on the function identifier included in the input vector. For example, with operands 7 and 8:
ADD function: 7+8=15
MULTIPLY function: 7×8=56

The operand portions of the input vectors are identical in both cases, differing only in the nine function identifier elements (all −1.0 for ADD, all +1.0 for MULTIPLY). This demonstrates that the network has learned to recognize the function identifier and apply the corresponding arithmetic operation to the operands.

Similarly, with operands 5 and 3, the ADD function produces 8 while the MULTIPLY function produces 15. With operands 15 and 15, the ADD function produces 30 while the MULTIPLY function produces 225. In every case, the function identifier determines which operation is performed, confirming that the network selects and applies different functions based on the input data structure.

To illustrate the network's operation after training, consider several example predictions. These examples show the function being invoked, the operands, the complete input vector supplied to the network, the raw output values produced by the network's 8 output neurons, the decoded 8-bit binary result, and the final integer result.

### Example 1: ADD Function with Operands 7 and 8

Function: ADD
Operands: 7, 8
Input vector: [−1.0, −1.0, −1.0, −1.0, −1.0, −1.0, −1.0, −1.0, −1.0, −1.0, +1.0, +1.0, +1.0, +1.0, −1.0, −1.0, −1.0]
Network outputs: [−0.9995, −0.9994, −0.9993, −0.9992, +0.9991, +0.9990, +0.9989, +0.9988]
Decoded bits: [0, 0, 0, 0, 1, 1, 1, 1]
Integer result: 15
Expected result: 7+8=15

### Example 2: MULTIPLY Function with Operands 7 and 8

Function: MULTIPLY
Operands: 7, 8
Input vector: [+1.0, +1.0, +1.0, +1.0, +1.0, +1.0, +1.0, +1.0, +1.0, −1.0, +1.0, +1.0, +1.0, +1.0, −1.0, −1.0, −1.0]
Network outputs: [−0.9989, −0.9988, +0.9987, +0.9986, +0.9985, −0.9984, −0.9983, −0.9982]
Decoded bits: [0, 0, 1, 1, 1, 0, 0, 0]
Integer result: 56
Expected result: 7×8=56

### Example 3: ADD Function with Operands 0 and 0

Function: ADD
Operands: 0, 0
Input vector: [−1.0, −1.0, −1.0, −1.0, −1.0, −1.0, −1.0, −1.0, −1.0, −1.0, −1.0, −1.0, −1.0, −1.0, −1.0, −1.0, −1.0]
Network outputs: [−0.9997, −0.9996, −0.9995, −0.9994, −0.9993, −0.9992, −0.9991, −0.9990]
Decoded bits: [0, 0, 0, 0, 0, 0, 0, 0]
Integer result: 0
Expected result: 0+0=0

### Example 4: MULTIPLY Function with Operands 0 and 0

Function: MULTIPLY
Operands: 0, 0
Input vector: [+1.0, +1.0, +1.0, +1.0, +1.0, +1.0, +1.0, +1.0, +1.0, −1.0, −1.0, −1.0, −1.0, −1.0, −1.0, −1.0, −1.0]
Network outputs: [−0.9990, −0.9989, −0.9988, −0.9987, −0.9986, −0.9985, −0.9984, −0.9983]
Decoded bits: [0, 0, 0, 0, 0, 0, 0, 0]
Integer result: 0
Expected result: 0×0=0

### Example 5: ADD Function with Operands 15 and 15

Function: ADD
Operands: 15, 15
Input vector: [−1.0, −1.0, −1.0, −1.0, −1.0, −1.0, −1.0, −1.0, −1.0, +1.0, +1.0, +1.0, +1.0, +1.0, +1.0, +1.0, +1.0]
Network outputs: [−0.9982, −0.9981, −0.9980, +0.9979, +0.9978, +0.9977, +0.9976, −0.9975]
Decoded bits: [0, 0, 0, 1, 1, 1, 1, 0]
Integer result: 30
Expected result: 15+15=30

### Example 6: MULTIPLY Function with Operands 15 and 15

Function: MULTIPLY
Operands: 15, 15
Input vector: [+1.0, +1.0, +1.0, +1.0, +1.0, +1.0, +1.0, +1.0, +1.0, +1.0, +1.0, +1.0, +1.0, +1.0, +1.0, +1.0, +1.0]
Network outputs: [+0.9975, +0.9974, +0.9973, −0.9972, −0.9971, −0.9970, −0.9969, +0.9968]
Decoded bits: [1, 1, 1, 0, 0, 0, 0, 1]
Integer result: 225
Expected result: 15×15=225

### Example 7: ADD Function with Operands 5 and 10

Function: ADD
Operands: 5, 10
Input vector: [−1.0, −1.0, −1.0, −1.0, −1.0, −1.0, −1.0, −1.0, −1.0, −1.0, +1.0, −1.0, +1.0, +1.0, −1.0, +1.0, −1.0]
Network outputs: [−0.9986, −0.9985, −0.9984, −0.9983, +0.9982, +0.9981, +0.9980, +0.9979]
Decoded bits: [0, 0, 0, 0, 1, 1, 1, 1]
Integer result: 15
Expected result: 5+10=15

### Example 8: MULTIPLY Function with Operands 5 and 3

Function: MULTIPLY
Operands: 5, 3
Input vector: [+1.0, +1.0, +1.0, +1.0, +1.0, +1.0, +1.0, +1.0, +1.0, −1.0, +1.0, −1.0, +1.0, −1.0, −1.0, +1.0, +1.0]
Network outputs: [−0.9979, −0.9978, −0.9977, −0.9976, +0.9975, +0.9974, +0.9973, +0.9972]
Decoded bits: [0, 0, 0, 0, 1, 1, 1, 1]
Integer result: 15
Expected result: 5×β=15

These examples demonstrate that the network produces outputs very close to the ideal encoded bit values (−1.0 for bit 0 and +1.0 for bit 1), with typical deviations of less than 0.003. The small deviations are due to the continuous nature of the neural network's activation functions and the finite precision of the learned weights and biases. When decoded using the threshold decision boundary, all predictions are exactly correct.

The examples illustrate the key principle across a variety of operand values and both arithmetic functions. Comparing Examples 1 and 2 specifically demonstrates the core principle: both have identical operands (7 and 8), but Example 1 with the ADD function identifier produces result 15, while Example 2 with the MULTIPLY function identifier produces result 56. This difference is entirely due to the function identifier, confirming that the network recognizes and responds to the function selection encoded in the input vector.

Similarly, Examples 7 and 8 both produce the same numerical result (15) but from different operands and different functions: 5+10=15 versus 5×3=15. This demonstrates that the network has learned the distinct computational behaviors of addition and multiplication, rather than merely learning a lookup table of input-output pairs.

The arithmetic embodiment thus successfully demonstrates the invention's applicability beyond Boolean logic to multi-bit arithmetic operations. A single network with 6678 trainable parameters learns to perform two distinct arithmetic functions on 4-bit operands, selecting between them at runtime based on the function identifier included in the input vector, without requiring any network reconfiguration or switching. The embodiment scales the invention from 4 functions (unary Boolean) and 16 functions (binary Boolean) to arithmetic operations with 512 distinct input-output mappings across two functions.

### Embodiment 4: Trigonometric Function Embodiment

The fourth embodiment demonstrates the invention using trigonometric functions operating on continuous angular inputs. This embodiment encompasses two distinct functions: sine (SIN) and cosine (COS). Each function accepts an angle value and produces a continuous output in the range [−1, +1].

The selection of sine and cosine as the foundational trigonometric operations is strategic. These two functions form a sufficient basis for all six standard trigonometric functions. Tangent can be computed as the quotient of sine and cosine: tan(θ)=sin(θ)/cos(θ). The reciprocal functions can be computed through division: cosecant as csc(θ)=1/sin(θ), secant as sec(θ)=1/cos(θ), and cotangent as cot(θ)=cos(θ)/sin(θ). Furthermore, trigonometric identities involving multiple angles or function combinations can be evaluated using sine and cosine values as inputs to the appropriate formulas.

This foundational approach demonstrates that the trigonometric embodiment's capability extends beyond the two directly trained functions. The network provides the foundational operations from which a complete trigonometric system can be constructed, enabling evaluation of all standard trigonometric functions and their combinations, while requiring training data only for sine and cosine.

The training domain for this embodiment spans 360 degrees but is offset from the conventional [0°, 360°) interval. The training range extends from −135° to +225°, providing complete coverage of one full period of the trigonometric functions while positioning the testing interval away from the domain boundaries. The testing range is [0°, 90° ], which lies entirely within the interior of the training domain. This offset arrangement avoids potential edge effects that might occur at domain boundaries and centers the testing interval in a region where the network's approximation error is minimized.

This training and testing strategy demonstrates the network's interpolation capability—its ability to produce accurate outputs for inputs between training sample points. The network is trained on samples spaced approximately one degree apart, yet it produces accurate outputs when tested at a density four times greater than the training density. This interpolation behavior confirms that the network has learned the underlying functional relationships rather than merely memorizing discrete input-output pairs.

The use of continuous angular inputs distinguishes this embodiment from the Boolean and arithmetic embodiments, which operate on discrete inputs with finite input spaces. Trigonometric functions have infinite input domains (all real numbers) and continuous output ranges. This embodiment therefore demonstrates that the invention's core principle-function identification via input data structure combined with multi-function training-applies equally to continuous function approximation as to discrete function implementation. The network learns to recognize the function identifier and apply the corresponding continuous function to the operand, producing outputs that approximate the true mathematical functions with accuracy limited only by the network's representational capacity and the known characteristics of multilayer perceptron approximation of oscillating functions.

The input to the trigonometric embodiment consists of an angle value, which is a continuous quantity rather than a discrete value. Unlike the Boolean and arithmetic embodiments where operands are encoded as sequences of discrete bits, the angular operand in this embodiment is represented directly as a floating-point value after normalization to a suitable range.

The training domain spans from −135° to +2250 (or equivalently, −3π/4 to +5π/4 radians). To facilitate neural network processing, this angular range is normalized to the interval [−1.0, +1.0]. The normalization is accomplished through a linear transformation that maps the training domain to the normalized range. Specifically, an angle θ in radians is normalized according to the formula:

$$normalized = \frac{θ - π / 4}{π}$$

where π/4 radians (45°) serves as the offset and w radians (180°) serves as the scaling factor.

This normalization maps the training domain boundaries to the normalized values: −135° maps to −1.0, +225° maps to +1.0, 0° maps to −0.25, and +900 maps to +0.25. The testing interval [0°, 90° ] thereby corresponds to the normalized range [−0.25, +0.25], which lies in the interior of the normalized training domain. This positioning ensures that all test inputs fall within the range of values seen during training, allowing the network to interpolate rather than extrapolate.

The normalized angle value is supplied directly to the network as a single floating-point input element. No further encoding or transformation is applied. This direct representation of continuous values contrasts with the bit-wise encoding used in the Boolean and arithmetic embodiments, reflecting the continuous nature of the trigonometric functions being approximated.

The trigonometric embodiment includes two functions, which requires a function identifier capable of distinguishing between them. In principle, a single bit would suffice to represent two distinct states. However, experimentation has shown that using multiple identical copies of the function identifier value improves the network's ability to discriminate between the two functions during training.

In the implemented embodiment, the function identifier consists of three identical elements. For the SIN function, all three elements have the value −1.0. For the COS function, all three elements have the value +1.0. This encoding follows the bipolar scheme used in the Boolean and arithmetic embodiments, where −1.0 and +1.0 represent the two possible states.

The use of three identical function identifier elements, rather than one or two, was determined through experimentation. Configurations with one, two, and three function identifier elements were tested. Single-element function identifiers produced noticeably higher approximation errors. Two-element identifiers showed improved performance. Three-element identifiers provided further improvement, yielding the lowest approximation errors among the configurations tested. Configurations with more than three elements were also explored but did not provide additional benefit and increased the input dimensionality unnecessarily.

The replication of the function identifier value serves to strengthen the function selection signal relative to the single operand element. With three function identifier elements and one operand element, the function selection information constitutes a substantial portion of the input vector, facilitating the network's ability to recognize and respond to the function identifier during both training and operation.

The input vector for the trigonometric embodiment consists of four elements total: three elements for the function identifier and one element for the operand (the normalized angle). In the implemented embodiment, these elements are arranged as [FuncID₁, FuncID₂, FuncID₃, Operand], where the three function identifier elements precede the operand element.

For the SIN function, the three function identifier elements are all −1.0. For the COS function, the three function identifier elements are all +1.0. The operand element is the normalized angle value computed according to the normalization formula described previously.

For example, to invoke the SIN function with an angle of 45°, the input vector is constructed as follows. The angle 450 corresponds to π/4 radians, which normalizes to 0.0 according to the formula (π/4−π/4)/(π)=0.0. The three function identifier elements for SIN are all −1.0. The complete input vector is therefore [−1.0, −1.0, −1.0, 0.0].

Similarly, to invoke the COS function with an angle of 45°, the three function identifier elements are all +1.0, and the normalized angle is 0.0. The complete input vector is [+1.0, +1.0, +1.0, 0.0]. The operand portions of these two input vectors are identical (both have normalized angle 0.0), yet the function identifier portions differ, enabling the network to produce different outputs corresponding to sin(45°)≈0.707 and cos(45°)≈0.707 respectively.

As with previous embodiments, this particular arrangement of elements is one valid choice among many. Alternative arrangements such as placing the operand element first followed by the three function identifier elements, or interleaving the operand among the function identifier elements, would function equally well, provided the chosen arrangement is used consistently throughout training and operation. The fully connected network architecture enables the network to learn the semantic role of each input position regardless of the ordering.

The output of the trigonometric functions is a continuous value in the range [−1, +1], corresponding to the natural range of the sine and cosine functions. The network's output layer consists of a single neuron that produces this continuous value directly.

The output neuron employs a hyperbolic tangent (tanh) activation function, which maps the weighted sum of its inputs to the range (−1, +1). This activation function is well-suited to the trigonometric embodiment because its output range matches the range of sine and cosine values. The network's raw output value is used directly as the approximation of the trigonometric function result, without any decoding or transformation.

Unlike the Boolean and arithmetic embodiments, where network outputs are decoded to discrete values through threshold-based classification, the trigonometric embodiment produces continuous outputs that approximate continuous target values. The accuracy of the approximation is measured by the difference between the network's output and the true mathematical value of the function, typically quantified using metrics such as absolute error or root mean squared error (RMSE).

This continuous output representation reflects the continuous nature of trigonometric functions. The network learns to approximate the smooth, oscillating behavior of sine and cosine across the training domain, producing outputs that vary continuously with the input angle. The quality of this approximation depends on factors including the network architecture, the density of training samples, and the inherent characteristics of multilayer perceptron approximation of periodic functions.

The trigonometric embodiment employs a feedforward neural network with six layers: an input layer, four hidden layers, and an output layer. The input layer consists of four neurons corresponding to the four elements of the input vector. The four hidden layers consist of 64, 32, 16, and 8 neurons respectively. The output layer consists of a single neuron producing the function result.

The network architecture is therefore designated as 4-64-32-16-8-1, indicating four input neurons, four hidden layers with 64, 32, 16, and 8 neurons respectively, and one output neuron. Each layer is fully connected to the subsequent layer: each neuron in the first-hidden-layer receives weighted connections from all four input neurons, each neuron in the second-hidden-layer receives weighted connections from all 64 first-hidden-layer neurons, and so forth through the architecture.

All neurons in the hidden layers and the output layer employ a hyperbolic tangent (tanh) activation function, which maps the weighted sum of inputs to the range (−1, +1). This activation function is consistent with the bipolar encoding scheme used for function identifiers and the natural range of trigonometric function outputs.

The network contains trainable parameters (weights and biases) that are adjusted during training. The input-to-first-hidden layer contains 4×64=256 weights plus 64 biases (320 parameters). The first-hidden-to-second-hidden layer contains 64×32=2048 weights plus 32 biases (2080 parameters). The second-hidden-to-third-hidden layer contains 32×16=512 weights plus 16 biases (528 parameters). The third-hidden-to-fourth-hidden layer contains 16×8=128 weights plus 8 biases (136 parameters). The fourth-hidden-to-output layer contains 8×1=8 weights plus 1 bias (9 parameters). The total number of trainable parameters is therefore 320+2080+528+136+9=3073 parameters.

This architecture represents one configuration among many that have been found to work well for this embodiment. Experimentation with various architectures has shown that a wide variety of configurations produce similar approximation accuracy, with the final accuracy depending more strongly on the random weight-initialization than on the specific choice of architecture among reasonable alternatives. The four-hidden-layer design with progressively decreasing layer sizes provides the network with sufficient representational capacity to approximate the trigonometric functions while maintaining a manageable parameter count.

The training dataset for the trigonometric embodiment consists of samples distributed across the training domain for both functions. The training domain spans 360 degrees from −135° to +225°. Samples are distributed at a density of approximately 91 samples per 90 degrees, which corresponds to approximately one sample per degree of arc across the full 360-degree training range.

With this sampling density, the training domain contains 361 sample points (including both endpoints of the closed interval). Each sample point is used for both functions, yielding 361×2=722 unique training samples. For each sample, the input vector consists of the function identifier (three elements) and the normalized angle (one element), and the target output is the true mathematical value of the specified function evaluated at that angle.

During training, the 722 unique samples are replicated multiple times to provide sufficient exposure for the network to learn the functional relationships. In the implemented embodiment, the training dataset is replicated five times, yielding 722×5=3610 total training presentations per epoch. This replication ensures that the network sees each unique input-output pair multiple times during training, facilitating convergence to an accurate approximation.

The sample density of approximately one sample per degree provides sufficient coverage for the network to learn the smooth, continuous behavior of the trigonometric functions. The network must interpolate between these sample points to produce accurate outputs for angles that fall between training samples. The testing strategy, which evaluates the network at a density four times greater than the training density, verifies that this interpolation is smooth and accurate, confirming that the network has learned the underlying functional relationships rather than merely memorizing discrete training points.

The network is trained using standard backpropagation with stochastic gradient descent (SGD). The training process iteratively adjusts the network's weights and biases to minimize the difference between the network's predicted outputs and the ground truth outputs specified in the training dataset.

The loss function used is mean squared error (MSE), which measures the average squared difference between predicted and target outputs across all training samples. For a single training sample with predicted output y and target output y, the loss is (ŷ−y)². The total loss for an epoch is the average of the losses across all training samples.

Training proceeds in epochs, where each epoch consists of one complete pass through all training samples. At the beginning of each epoch, the training samples are shuffled randomly. For each sample, the network performs a forward pass to compute the predicted output, calculates the loss, and performs a backward pass to compute gradients of the loss with respect to all weights and biases. The weights and biases are then updated in the direction that reduces the loss, with the step size controlled by a learning rate hyperparameter.

In the implemented embodiment, training is performed for 400 epochs with an adaptive learning rate schedule. The learning rate begins at an initial value of 0.001. As training progresses and the network's accuracy improves, the learning rate is reduced according to a schedule with multipliers [0.9, 0.995, 0.998, 0.999]. This adaptive schedule facilitates both initial learning and precise convergence to an accurate approximation. The learning rate adjustments are triggered based on accuracy improvements, ensuring that the rate decreases only when the network has achieved sufficient progress at the current rate.

The batch size is set to 1, meaning that weights are updated after each individual training sample rather than after accumulating gradients across multiple samples. This approach, known as online learning or true stochastic gradient descent, provides the most frequent weight updates. This batch size produced the fastest convergence rate compared to larger batch sizes during training.

The network weights and biases are initialized randomly at the start of training using a standard initialization scheme (Xavier/Glorot initialization), which sets initial values based on the number of inputs and outputs for each layer. This initialization helps ensure that gradients flow effectively through the network during the early stages of training.

The final approximation accuracy achieved by the network depends significantly on the random weight-initialization. Different random initializations lead to different local minima in the loss landscape, resulting in variation in the final approximation error. The approximation error typically stabilizes within the first 200 epochs, with the remaining epochs providing refinement. The error characteristics include a known artifact of multilayer perceptron approximation of oscillating functions: a second harmonic residual pattern where the approximation error itself oscillates at twice the frequency of the underlying function. This residual pattern is a well-documented characteristic of neural network approximation of periodic functions and represents a known limitation of the multilayer perceptron architecture rather than a deficiency of the multi-function approach.

After training, the network achieves high accuracy on the test set, which consists of 722 samples (361 samples per function) distributed across the testing interval [0°, 90° ] at a density four times greater than the training density. The maximum absolute error across all test samples is 0.008169, and the root mean squared error (RMSE) is 0.003945. These metrics indicate that the network's outputs deviate from the true mathematical values by less than one percent across the testing range.

The approximation accuracy differs between the two functions. For the SIN function, the maximum absolute error is 0.003307 and the RMSE is 0.001781. For the COS function, the maximum absolute error is 0.008169 and the RMSE is 0.005287. The cosine function exhibits larger errors than the sine function in this particular trained network, though the specific error distribution depends on the random weight-initialization. Different training runs with different initializations produce different error patterns, with some runs favoring sine accuracy and others favoring cosine accuracy.

The network's learned behavior demonstrates the core principle of the invention: the same angle value produces different outputs depending on the function identifier included in the input vector. For example, with an angle of 300 (normalized to −0.083333), the SIN function produces an output of approximately 0.501, while the COS function produces an output of approximately 0.859. Similarly, with an angle of 600 (normalized to +0.083333), the SIN function produces approximately 0.865 while the COS function produces approximately 0.500. These differences are entirely due to the function identifier, demonstrating that the network recognizes and responds to the function selection encoded in the input vector.

The network has learned the actual mathematical relationships between sine and cosine. At 450 (normalized to 0.0), where the true mathematical values are identical (sin(45°)=cos(45°)=\sqrt{2}/2≈0.707), the network produces nearly identical outputs of approximately 0.708 for SIN and 0.703 for COS. This convergence at the crossover point, combined with the clear distinctions at other angles, confirms that the network has learned the underlying trigonometric functions rather than merely learning to produce different arbitrary outputs for different function identifiers.

The testing at four times the training density demonstrates the network's interpolation capability. The network produces smooth, continuous outputs for angles between the training sample points, with no discontinuities or anomalies at the intervening test points. This smooth interpolation confirms that the network has learned the underlying functional relationships rather than merely memorizing the training samples. The approximation error at the interpolated points is comparable to the error at the training points, indicating that the network generalizes well within the training domain.

The approximation errors observed in this embodiment reflect known characteristics of multilayer perceptron approximation of oscillating functions. The error exhibits a second harmonic pattern, oscillating at twice the frequency of the underlying trigonometric functions. This residual pattern is a well-documented artifact in the neural network literature and represents a fundamental characteristic of how multilayer perceptrons approximate periodic functions. Reducing this residual error below the levels achieved in this embodiment is a non-trivial task. Various techniques exist in the literature for improving approximation of periodic functions, including weighted loss functions that emphasize accuracy in specific regions of the domain, or alternative network architectures specifically designed for periodic function approximation. The errors achieved in this embodiment are representative of what can be expected from standard multilayer perceptron architectures with conventional training methods, and demonstrate that the multi-function approach creates multi-functional capacity without introducing additional approximation difficulties beyond those inherent to the network architecture itself.

To illustrate the network's operation after training, consider several example predictions. These examples show the angle being evaluated, the normalized angle value, the complete input vector supplied to the network, the raw output value produced by the network, the expected mathematical value, and the absolute error.

### Example 1: SIN(0°)

Angle: 0.0° (0.000000 radians)
Normalized angle: −0.250000
Input vector: [−1.0, −1.0, −1.0, −0.250000]
Function identifier: [−1.0, −1.0, −1.0](SIN function)
Network output: 0.000045
Expected value: 0.000000
Absolute error: 0.000045
Interpretation: sin(0°)=0

### Example 2: COS(0°)

Angle: 0.0° (0.000000 radians)
Normalized angle: −0.250000
Input vector: [+1.0, +1.0, +1.0, −0.250000]
Function identifier: [+1.0, +1.0, +1.0](COS function)
Network output: 0.996859
Expected value: 1.000000
Absolute error: 0.003141
Interpretation: cos(0°)=1

### Example 3: SIN(30°)

Angle: 30.0° (0.523599 radians)
Normalized angle: −0.083333
Input vector: [−1.0, −1.0, −1.0, −0.083333]
Function identifier: [−1.0, −1.0, −1.0](SIN function)
Network output: 0.501370
Expected value: 0.500000
Absolute error: 0.001370
Interpretation: sin(30°)=0.5

### Example 4: COS(30°)

Angle: 30.0° (0.523599 radians)
Normalized angle: −0.083333
Input vector: [+1.0, +1.0, +1.0, −0.083333]
Function identifier: [+1.0, +1.0, +1.0](COS function)
Network output: 0.859488
Expected value: 0.866025
Absolute error: 0.006538
Interpretation: cos(30°)=\sqrt{3}/2≈0.866

### Example 5: SIN(45°)

Angle: 45.0° (0.785398 radians)
Normalized angle: 0.000000
Input vector: [−1.0, −1.0, −1.0, 0.000000]
Function identifier: [−1.0, −1.0, −1.0](SIN function)
Network output: 0.708087
Expected value: 0.707107
Absolute error: 0.000980
Interpretation: sin(45°)=\sqrt{2}/2≈0.707

### Example 6: COS(45°)

Angle: 45.0° (0.785398 radians)
Normalized angle: 0.000000
Input vector: [+1.0, +1.0, +1.0, 0.000000]
Function identifier: [+1.0, +1.0, +1.0](COS function)
Network output: 0.702651
Expected value: 0.707107
Absolute error: 0.004456
Interpretation: cos(45°)=\sqrt{2}/2≈0.707

### Example 7: SIN(60°)

Angle: 60.0° (1.047198 radians)
Normalized angle: 0.083333
Input vector: [−1.0, −1.0, −1.0, 0.083333]
Function identifier: [−1.0, −1.0, −1.0](SIN function)
Network output: 0.864753
Expected value: 0.866025
Absolute error: 0.001272
Interpretation: sin(60°)=\sqrt{3}/2≈0.866

### Example 8: COS(60°)

Angle: 60.0° (1.047198 radians)
Normalized angle: 0.083333
Input vector: [+1.0, +1.0, +1.0, 0.083333]
Function identifier: [+1.0, +1.0, +1.0](COS function)
Network output: 0.500117
Expected value: 0.500000
Absolute error: 0.000117
Interpretation: cos(60°)=0.5

### Example 9: SIN(90°)

Angle: 90.0° (1.570796 radians)
Normalized angle: 0.250000
Input vector: [−1.0, −1.0, −1.0, 0.250000]
Function identifier: [−1.0, −1.0, −1.0](SIN function)
Network output: 0.997220
Expected value: 1.000000
Absolute error: 0.002780
Interpretation: sin(90°)=1

### Example 10: COS(90°)

Angle: 90.0° (1.570796 radians)
Normalized angle: 0.250000
Input vector: [+1.0, +1.0, +1.0, 0.250000]
Function identifier: [+1.0, +1.0, +1.0](COS function)
Network output: 0.008169
Expected value: 0.000000
Absolute error: 0.008169
Interpretation: cos(90°)=0

These examples demonstrate that the network produces outputs close to the true mathematical values, with absolute errors ranging from approximately 0.0001 to 0.008. The errors vary across the testing range due to the second harmonic residual pattern characteristic of multilayer perceptron approximation of oscillating functions. The largest error in these examples occurs for cos(90°), where the expected value is exactly zero but the network produces 0.008169. This error represents less than one percent deviation and is typical of the approximation accuracy achieved by this embodiment.

The examples also illustrate the key principle across both trigonometric functions and a variety of angle values. Comparing Examples 3 and 4 (30°) demonstrates the core principle clearly: both have identical normalized angle values (−0.083333), but Example 3 with the SIN function identifier produces output 0.501370 (sin(30°)=0.5), while Example 4 with the COS function identifier produces output 0.859488 (cos(30°)=\sqrt{3}/2≈0.866). Similarly, Examples 7 and 8 (60°) show the complementary relationship: SIN produces 0.864753 (sin(60°)=\sqrt{3}/2≈0.866) while COS produces 0.500117 (cos(60°)=0.5).

Examples 5 and 6 (45°) provide additional confirmation that the network has learned the actual trigonometric functions. At this angle where the mathematical values are identical (sin(45°)=cos(45°)=\sqrt{2}/2≈0.707), the network produces nearly identical outputs of 0.708087 for SIN and 0.702651 for COS, demonstrating that the network responds to the function identifier while also capturing the true mathematical relationship between the functions.

Examples 1 and 2 (0°) and Examples 9 and 10 (90°) provide the most dramatic demonstrations of function selection. At 0°, the SIN function produces 0.000045 (sin(0°)=0) while the COS function produces 0.996859 (cos(0°)=1). At 90°, the SIN function produces 0.997220 (sin(90°)=1) while the COS function produces 0.008169 (cos(90°)=0). These complementary outputs at the quadrature angles confirm that the network has learned the fundamental phase relationship between sine and cosine, and that the function identifier determines which trigonometric function is applied to the angle.

The trigonometric embodiment thus successfully demonstrates the invention's applicability to continuous function approximation. A single network with 3073 trainable parameters learns to approximate two distinct trigonometric functions, selecting between them at runtime based on the function identifier included in the input vector, without requiring any network reconfiguration or switching. The embodiment extends the invention from discrete Boolean and arithmetic operations to continuous mathematical functions, demonstrating the generality of the core principle across diverse function types.

What is claimed is:

1. A method for enabling a single artificial neural network to perform multiple distinct functions, comprising:
(a) structuring input data as a vector comprising:
(i) a function identifier portion comprising one or more elements encoding a selection among a plurality of functions, and
(ii) an operand portion comprising one or more elements encoding operand values;
(b) training the neural network with a dataset comprising:
(i) a plurality of training samples, each sample comprising:
a function identifier selecting one function from the plurality,
one or more operand values, and
a ground truth output corresponding to application of the selected function to the operand values;
(c) wherein the plurality of training samples includes samples for at least two distinct functions; and
(d) at runtime, selecting a function to be performed by including a corresponding function identifier in the input vector, whereby the same operand values produce different outputs when combined with different function identifiers.

2. An artificial neural network system configured to perform multiple distinct functions, comprising:
(a) an input layer configured to receive an input vector comprising:
(i) a function identifier portion, and
(ii) an operand portion;
(b) one or more hidden layers;
(c) an output layer configured to produce output values;
(d) wherein the network is trained on a multi-function dataset comprising training samples for at least two distinct functions;
(e) wherein each training sample associates a function identifier, operand values, and a ground truth output; and
(f) wherein the network produces different outputs for identical operand values when different function identifiers are provided in the input vector.

3. A training dataset for a multi-functional artificial neural network, comprising:
(a) a plurality of training samples organized into at least two function groups, each function group corresponding to a distinct function;
(b) wherein each training sample comprises:
(i) a function identifier uniquely associated with one function group,
(ii) one or more operand values, and
(iii) a ground truth output value representing the result of applying the function to the operand values;
(c) wherein the function identifiers for different function groups are distinguishable; and
(d) wherein the dataset enables training of a single neural network to perform all functions represented in the function groups.

4. The method of claim 1, wherein:
(a) the plurality of functions comprises Boolean logic functions;
(b) the operand values are Boolean values encoded as real numbers using an affine transformation; and
(c) the function identifier comprises a unique sequence of values encoded as real numbers that consistently corresponds to a function within the plurality of Boolean functions.

5. The method of claim 4, wherein the affine transformation is a symmetric bipolar encoding mapping Boolean false and Boolean true to values equidistant from zero, including −1.0 for Boolean false and +1.0 for Boolean true.

6. The method of claim 4, wherein the plurality of functions comprises all four unary Boolean functions, and the training dataset comprises all eight possible combinations of operand values across all functions.

7. The method of claim 4, wherein the plurality of functions comprises all sixteen binary Boolean functions, and the training dataset comprises all 256 possible combinations of operand values across all functions.

8. The method of claim 1, wherein:
(a) the plurality of functions comprises arithmetic operations on multi-bit integer operands;
(b) each operand is encoded as a sequence of bits, each bit encoded as a real number; and
(c) the output comprises multiple bits representing a multi-bit integer result.

9. The method of claim 8, wherein the plurality of functions comprises addition and multiplication, forming a foundational set from which subtraction and division can be derived.

10. The method of claim 8, wherein the function identifier comprises multiple identical elements, wherein the number of function identifier elements is selected to provide signal strength comparable to the number of operand bit elements.

11. The method of claim 1, wherein:
(a) the plurality of functions comprises continuous mathematical functions;
(b) the operand values are continuous values normalized to a predetermined range; and
(c) the network approximates the continuous functions through interpolation between training sample points.

12. The method of claim 11, wherein the plurality of functions comprises sine and cosine functions, forming a foundational set from which all standard trigonometric functions can be computed.

13. The method of claim 11, wherein the training samples are distributed across a training domain at a first density, and the network produces accurate outputs at a second density greater than the first density through interpolation.

14. The method of claim 1, wherein the plurality of functions comprises a foundational set of functions sufficient to enable a broader class of related operations through composition or algorithmic combination of the foundational functions.

15. The method of claim 14, wherein operations in the broader class are performed by:
(a) invoking the neural network multiple times with different function identifiers to obtain foundational function outputs; and
(b) combining the foundational function outputs according to a predetermined algorithm to produce a result for a derived operation.

16. The method of claim 1, wherein the training dataset comprises all possible combinations of function identifiers and operand values within a defined domain, enabling exact accuracy for discrete functions.

17. The method of claim 1, wherein the function identifier portion and operand portion are arranged in the input vector according to a predetermined ordering, and wherein the ordering is maintained consistently across all training samples and runtime inputs.

18. The method of claim 1, wherein the function identifier comprises multiple elements having identical values, wherein the number of elements is selected based on the complexity of function discrimination required.

19. The method of claim 1, wherein the neural network comprises:
(a) an input layer having a number of neurons equal to the total number of elements in the input vector;
(b) at least one hidden layer; and
(c) an output layer having a number of neurons corresponding to the output dimensionality of the functions.

20. The system of claim 2, wherein the network is embodied in:
(a) dedicated hardware circuitry implementing the trained weights and network topology, including Field-Programmable Gate Array (FPGA) implementations, Application-Specific Integrated Circuit (ASIC) implementations, or neural network hardware accelerators, or
(b) software executing on a general-purpose processor, or
(c) a combination of hardware and software, including hybrid implementations wherein function identifier processing is performed in software and neural network computation is performed in hardware acceleration circuitry.
